(19) United States
(12) Patent Application Publication
(10) Pub. No.: US 2015/0356607 A1
(43) Pub. Date: Dec. 10, 2015

(54) DYNAMIC CUSTOMER ENGAGEMENT SYSTEM OFFERING BENEFITS

(71) Applicant: ARGELA YAZILIM VE BILISIM TEKNOLOJILERI SAN. VE TIC. A.S., Istanbul (TR)

(72) Inventors: SEYHAN CIVANLAR, ISTANBUL (TR); MUSTAFA ERGEN, ISTANBUL (TR); NAZLI GUNEY, ISTANBUL (TR); OGUZ SUNAY, ISTANBUL (TR); HALIT NEBI GURSOY, ISTANBUL (TR)

(21) Appl. No.: 14/299,308

(22) Filed: Jun. 9, 2014

(51) Int. Cl. G06Q 30/02; H04W 12/04; H04M 1/725; H04W 4/02

(52) U.S. Cl. CPC G06Q 30/0261; H04W 4/025; H04W 12/04; H04M 1/72572; H04W 88/02

(57) ABSTRACT

A system and method is provided with a main software system for benefit givers' and takers' subscription, user authentication, benefit entry and modification, a completely distributed software and hardware system where each component is located at a benefit giver's (company) premises for detecting users' location, local benefit generation in communications with the main software system and benefit redemption, and a client application designed for mobile handsets in communications with the distributed software component for a user to receive benefits and redeem them at the location of the benefit generating company.

### BACKGROUND OF THE INVENTION

1. Field of Invention

The disclosed invention generally relates to the field of large-scale multi-user software platforms designed for service providers offering campaign, gift and promotion management to enhance customer engagement. More specifically, it relates to a distributed system operating in a manner resilient to network connectivity loss to generate an instant personalized benefit for a user, which leverages real-time user location information obtained from one or more of a wireless, mobile or fixed telecommunications service, an internet-based service, a social networking service, a location-based service or application including the global positioning system (GPS) or information directly provided by the user. Based on location, a benefit data (i.e., a gift or coupon) is generated pertaining to one or more companies and/or one or more recipients.

2. Discussion of Related Art

Customarily, coupons are issued by manufacturers of consumer goods or retailers to be used in retail stores as a part of sales promotions. They are often widely distributed through mail, magazines, newspapers, Internet or coupon books directly from the retailer, and mobile devices such as cell phones. Since only price conscious consumers are likely to spend the time to claim the savings, coupons enable retailers to offer a lower price only to those consumers who would otherwise go elsewhere. In addition, coupons can also be targeted selectively to regional markets in which price competition is fierce. Coupons can be used to research the price sensitivity of different groups of buyers (by sending out coupons with different dollar values to different groups). In addition, it is generally assumed that buyers who take the effort to collect and use coupons are more price sensitive than those who do not. Traditionally, coupons are generic, i.e., the same coupon is generated for everyone.

A step up of this generic coupon concept is a “personalized coupon” of a retailer in which the profile information of the recipient is used to generate the coupon (e.g., based on person's city, interest areas, etc.). The coupon is delivered directly to the user via an e-mail or an instant message or SMS. For the past few years, we have been seeing personalized coupon offerings through companies like GROUPON.

Another step up of the generic coupon concept is a “location based coupon”, i.e., for which the recipient manually or automatically indicates his/her current location, say using his/her cell phone, and then a targeted coupon applicable to a store in the vicinity of the user is generated and sent to the user's cell phone via SMS or a special coupon application.

Combining these concepts, a “location-based and personalized coupon” of a retailer can be generated if the recipient signs up to; for example, a web-site and/or a mobile application, indicating his/her interest areas and other profile/preference information. Such a coupon has the following properties:

Location Based;

Personalized;

Delivered to the recipient in real-time.

In prior art, there are a number of patent applications that are related to the concepts described above. For instance, in the U.S. Pat. No. 8,583,723 entitled, “Receiving Location Based Advertisements On A Wireless Communication Device”, a method and a system are presented which, in addition to mobile user devices, employ a plurality of access points connected to a network and arranged at known locations in a geographic region, and a plurality of information providers connected to the same network. The method as implemented in the mobile device is used to (1) transmit geographical location of the mobile device (2) transmit identification information for the user (3) receive promotion information customized for the user (based on the location of the active access point or the user's profile) which (i) corresponds to possible future actions of the user (ii) depends upon the wirelessly transmitted geographic location and past actions of the user (iii) is generated in response to the geographic location, and finally (4) present the promotion information at the wireless communication device.

In the U.S. Pat. No. 8,682,350 entitled, “Location-Based Advertising Message Serving For Mobile Communication Devices”, embodiments of a location sharing network manager process are described. The location-aware mobile communication system has a location determination component determining the relative locations of a plurality of mobile devices within a defined area. This component accepts input from the mobile user, GPS technology, WiFi positioning technology, Bluetooth technology, Radio Frequency signal technology and cellular identification technology. The advertising platform provides a mechanism for advertisers to provide location-based coupons. The coupons are delivered to users who have opted-in to receive discounts and promotions via text messages, coupons and/or some graphic element within the application provided by the location-based social network manager. In general, the location-based social network manager comprises a mobile application that provides the location-based services. This application includes a map display component displaying a scalable map on each mobile device. On this display, in addition to the ads and coupons transmitted by the advertising platform manager, it is possible to visualize locations of other mobile devices in the defined area, where these other mobile devices have allowed their positions to be disclosed to both the system and the mobile device. An advertisement is provided to a mobile user in response to a search, proximity to a location and/or during defined time periods. Although location information is used in generating advertisements, this patent application does not describe an intelligent system that can generate personalized benefits.

In the U.S. Pat. No. 8,682,350, a mobile device is described which has a circuitry for position detection, a circuitry for obtaining commercial information related to the position, a pattern detection circuitry configured to detect patterns based on the position information and the commercial information, and finally an information conveying circuitry to convey information to the user of the mobile device based on the detected pattern. Also, a method is claimed for obtaining position information and commercial information, detecting a pattern and conveying information to a user of the mobile device.

In order to address the problem of how to measure the performance of location-based advertising systems and methods, in the U.S. Pre-Grant Patent Publication 20120245995, a method and a system for enabling location based advertisement delivery with pay for performance are presented. The method and system serves to track the behavior of the mobile user after the advertisement reaches him. The advertisement costs of subscribing businesses are calculated based on either cost per visit (CPV) or cost per transaction (CPT). For CPV calculations it is sufficient that the mobile user visit the business location; for CPT-based method it is also important that the mobile user makes a payment at the location he visits.

In all of these inventions, the main idea is to deliver mobile users location-based advertisement messages of companies, which may be personalized using either the profile data provided by the recipients or the past and/or current actions of the users that trigger delivery of messages. The U.S. Pat. No. 7,496,527, on the other hand, centers on a concept for remote purchasing of products and services, where the buyer, who is a real person, specifies a location for the recipients to claim the products and services purchased. The method and system of the invention facilitates a third party purchase by receiving an instruction from a purchaser to purchase at least one product or service for a prospective recipient at a venue designated to provide that product or service to the recipient in person, with identification information regarding at least the recipient, the product or service and the venue provided by the purchaser, and sending, upon reception of the first instruction, a second instruction from the system to the venue to identify at least the recipient and the product or service purchased.

The system in the U.S. Pat. No. 7,496,527 for remote purchasing of products or services acts like an intermediary for purchasers and venues as well as for purchasers and recipients, which allows purchasers to be at a remote location during purchasing and claiming of products or services. The system in U.S. Pat. No. 7,496,527 lacks intelligence at the company locations, so-called venues, due mainly to the objective of being an intermediary. Our aim in this invention, however, is to present a system and a method, which transforms the idea of a coupon or a gift into a benefit, and achieves this result by enabling both real people and companies to provide recipients with benefit data. The system of this invention is decentralized and has a benefit agent which is deployed by the participant company at the company premises, which performs on-site user verification and acts on behalf of the company to locally distribute benefits to mobile users through a local benefit data processing component.

### SUMMARY OF THE INVENTION

A distributed system and method will be shown in the embodiments below for dynamic location-based benefit generation and benefit redemption, which can operate in a manner resilient to loss (or lack) of network connectivity. The system has (1) a main software system component for benefit givers' and takers' subscription, user authentication, benefit entry and modification, retrieval of information from social networking and location-based applications, and a recommendation engine, (2) a completely distributed software and hardware system where each component is located at a benefit giver's (i.e., company) premises for detecting users' location, local benefit generation in communications with the main software system and benefit redemption, and (3) a client application designed for mobile handsets in communications with the distributed software component for a user to receive benefits and redeem them at the location of benefit generating company.

In one embodiment, the present invention discloses a benefit-agent subsystem located within a premises associated with a company comprising: (a) a processor; (b) a storage storing instructions; (c) at least one communication interface receiving instructions from the processor to communicate with at least one client within the premises; (d) a locator receiving instructions from the processor to communicate with the at least one client via the communication interface and identifying location of the at least one client within the premises; (e) an authenticator receiving instructions from the processor to communicate with the at least one client via the communication interface and authenticating the at least one client within the premises, the authenticating based on a first verification information stored locally in the storage and a second verification information received from the at least one client; and (f) a benefit generator receiving instructions from the processor to generate a benefit for the at least one client within the premises and to communicate the benefit to the at least one client,where the benefit agent subsystem is configured to communicate both asynchronously and synchronously with either the client within the premises or a remote main subsystem when reconciling benefit details.

In another embodiment, the present invention discloses a method as implemented by a benefit-agent subsystem located within a premises associated with a company comprising: (a) communicating with at least one client within the premises; (b) communicating with the at least one client via the communication interface and identifying location of the at least one client within the premises; (c) communicating with the at least one client via the communication interface and authenticating the at least one client within the premises, the authenticating based on a first verification information stored locally in a storage and a second verification information received from the at least one client; and (d) generating a benefit for the at least one client within the premises and communicating the benefit to the at least one client, (e) where the benefit agent subsystem is configured to communicate both asynchronously and synchronously with either the client within the premises or a remote main subsystem when reconciling benefit details.

In yet another embodiment, the present invention discloses a method to generate a benefit by a first client for use by a second client, the benefit redeemable within a premises of a company, the method comprising: receiving a selection of a benefit from the first client for use by the second client; transmitting the benefit selected by the first client to the second client in real-time when the second client is within the premises of the company; receiving confirmation that the benefit was successfully redeemed by the second client where the first user is billed for any charges associated with the benefit; and transmitting a redemption notification to the first client.

In yet another embodiment, the present invention discloses a method to generate a benefit by a first client for use by a second client, the benefit redeemable within a premises of a company, the method comprising: receiving a subscription request from the first client requesting notification of location of the second client; pushing notification with location of the second client to the first client; receiving a selection of a benefit from the first client for use by the second client; transmitting the benefit selected by the first client to the second client in real-time when the second client is within the premises of the company; receiving confirmation that the benefit was successfully redeemed by the second client where the first user is billed for any charges associated with the benefit; and transmitting a redemption notification to the first client.

### BRIEF DESCRIPTION OF THE DRAWINGS

FIG. 1A illustrates the block diagram of the apparatus of the invention.

FIG. 1B illustrates possible network connectivity scenarios.

FIG. 2 illustrates the block diagram of the main subsystem of the invention.

FIG. 3A illustrates the block diagram of the “Benefit Agent” of the invention.

FIGS. 3B-D illustrate various non-limiting examples of the method associated with the present invention.

FIG. 4 illustrates the interfaces and actors of the system of the invention.

FIG. 5 depicts the flowchart for the subscription process.

FIG. 6 depicts the flowchart for receiving a benefit at a location.

FIG. 7 depicts the flowchart for receiving a gift at a location.

FIG. 8 depicts the flowchart of the benefit redemption process.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention describes a system and method for delivering personalized and location-based benefit data in real-time to a person or a group of people from a person or a group of people possibly accompanied by a company or a group of companies, where social networking and a recommendation engine aid the benefit-givers in choosing the type and timing of the benefit data to incorporate intelligence into decision making

The present invention generalizes the concept of a “coupon” to a “benefit” by embracing a “gift” in the same category with a coupon. Furthermore, the present invention revises the “issuer” of the “benefit” from being a company (such as a retailer or producer of goods and services) to being a person or a group of people possibly accompanied by a single company or a group of companies. The “benefit” is generated in “real-time”, for a specific “location” (such as a store or a shopping mall), in a “personalized way” using personal preferences and is delivered to a recipient or a group of recipients for instant redemption or a later-time redemption. The dimension of social networking is added (1) to increase the viral effects of the benefit (i.e., distributing to or sharing the benefit with friends); (2) to acquire location information (e.g. using “check-in” feature); (3) to obtain important personal dates such as birthdays; and (4) to gather or deduce profile/preference information.

The system and method of the present invention enables generation of a benefit which is:
Sent from person(s) and possibly company(s) to person(s);
Location based;
Personalized;
Delivered to recipient person(s) in real-time (i.e., benefit is generated on the fly);
Redemption based (i.e., charging and billing is involved);
Social Network associated (i.e., social networking contacts and important dates are used).

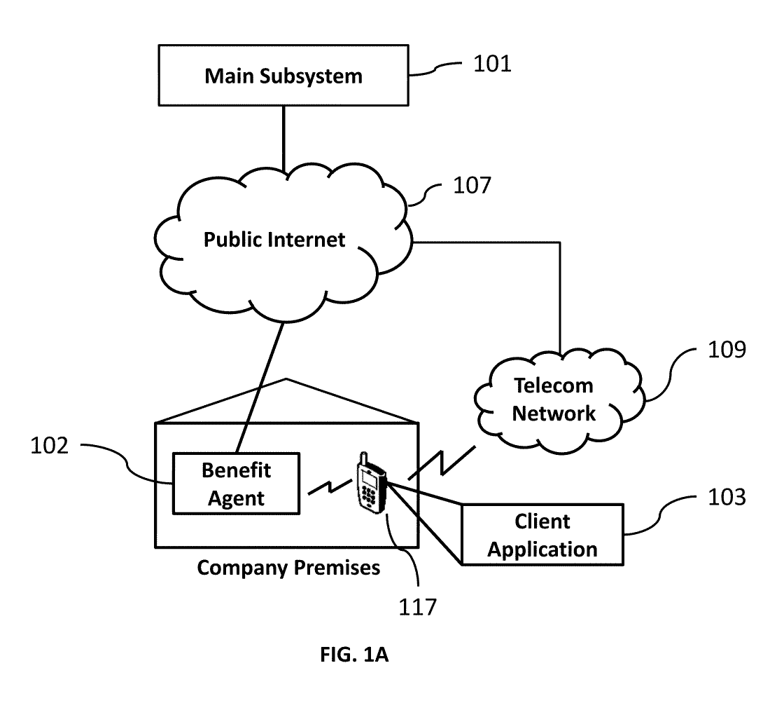

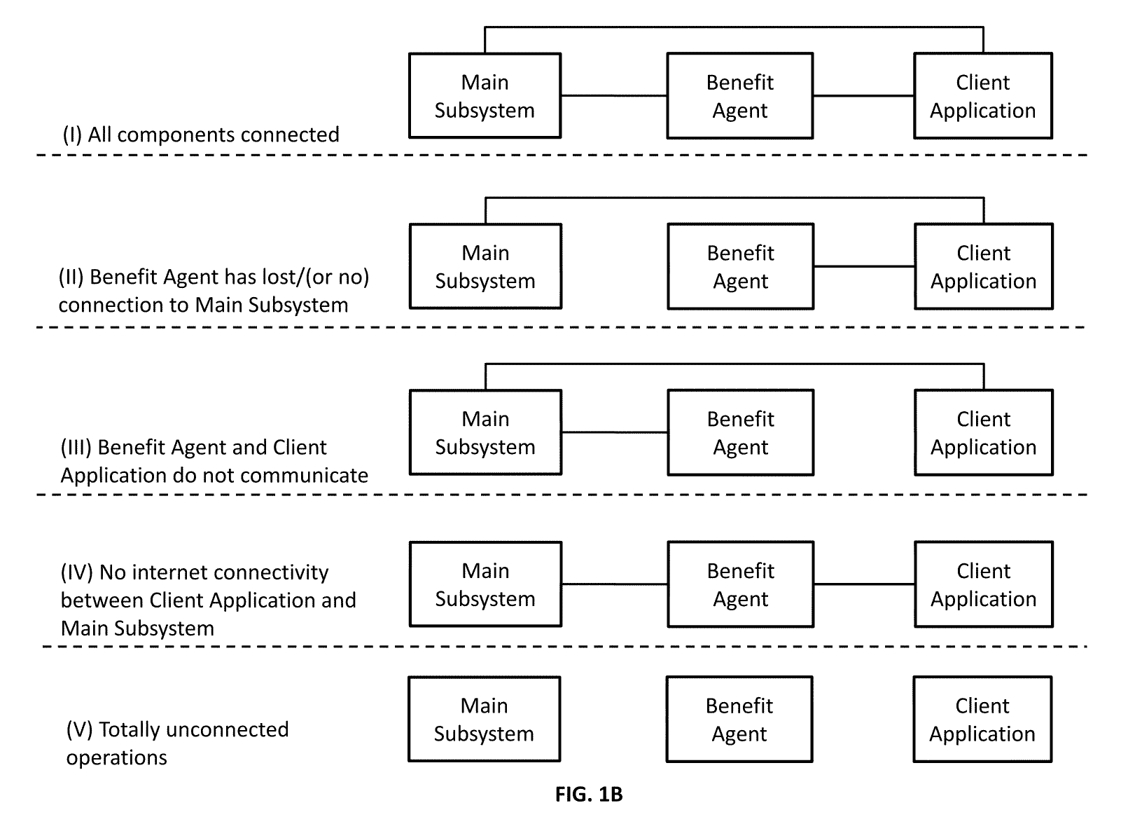

The “gift” concept as a benefit constitutes a powerful and unique way to monetize the notions of social networks and location services in a combined way, which allows people to purchase real goods for their friends. In doing so, companies can combine coupons with gifts of real people for even a more powerful marketing strategy. Obviously, combining gift and coupon as a benefit requires the system to be far more complex than simply generating coupons—as it has to handle billing. The “gift” concept of this invention has the following attributes:
Turns “virtual gift giving” concept (e.g., en electronic birthday card) of social networks into “real gift giving”.
Leverages location information of users.
Creates immediate revenues for participating companies.
   The overall system is comprised of three main components as illustrated in FIG. 1A:

(1) Main subsystem 101 is where information related to subscribing users and companies that generate benefit data is entered, and benefit data for users is generated and delivered in real-time.

(2) Benefit Agent 102 is located at company premises and basically pin-points the location of a user, authenticates the user and reports the location of that user to Main Subsystem 101, and can generate a benefit locally. It also has a bar code reader which can scan a barcode of a gift or coupon. There may be many Benefit Agents in a network, each one located at a company's premises. Benefit Agent is needed for users that are indoors because GPS technology will only work outside.

(3) Client application 103 runs on user's mobile handset and communicates with Benefit Agent 102 so that it can detect user's location. Client Application 103 may receive benefit data directly from Benefit Agent 102 or Main Subsystem 101.

Benefit Agent 102 communicates with Main Subsystem 101 through Public Internet 107 using IP protocol. Similarly, Benefit Agent 102 and Client Application 103 communicate with IP protocol over a wireless interface such as IEEE 802.11, a cellular interface such as 3G or 4G, or through a Bluetooth interface. Client Application 103 is located on a user's mobile handset 117, which may be attached to telecommunications network 109.

The overall system is designed in such a way that if connectivity between any two components of the system is lost, it still can operate in an asynchronous manner. Different connectivity loss scenarios are depicted in FIG. 1B. Before explaining the communications flow between system components for the scenarios of FIG. 1 B, let's explain a method developed for the present invention for benefit verification and benefit expiration.

In order for the Benefit Agent to verify and expire a benefit, the following variables are used:
The Key(benefit) is a key that is sent by Main Subsystem 101 or Benefit Agent 102 to Client Application 103 associated with a particular benefit.
The Key(benefit_agent) is a key associated with a particular Benefit Agent. This key is either provisioned (pre-configured) in that Benefit Agent or sent or periodically updated by Main Subsystem 101, if there is connectivity between Benefit Agent and Main Subsystem.
The Exp_Timer(benefit) is a timer used to age and expire a particular benefit or as a client application parameter setting to expire all benefits stored in a Client Application after display.
A Benefit Agent can verify a benefit using Key(benefit) and Key(benefit_agent) using:
   Verification=ƒ(Key[benefit], Key[benefit_agent])=1(verified)=(not verified)

The function ƒ[ . . . ] and the verification process is stored in the Benefit Agent. Although the verification process is described through use of keys, there may be alternative methods such as image matching, barcode matching and other types of verification methods applicable where one piece of the verification is coming from the client application and the other piece is stored in the benefit agent.

The Exp_Timer(benefit) is used by Client Application 103 to expire a particular benefit. This is specifically useful when Client Application has no connectivity to the serving Benefit Agent or Main Subsystem to have them send a message to discard a used benefit.

In scenario (I) of FIG. 1B, all three components of the overall system are able to communicate with one another (as illustrated in FIG. 1A). In this ideal scenario, Client Application 103 can communicate with Benefit Agent 102. Thereby, Benefit Agent 102 detects the presence of Client Application 103 through the local connectivity, and can generate a personalized-benefit for the user by optionally using the intelligence of Main Subsystem 101 and send the benefit as well as the associated Key(benefit) and Exp_Timer(benefit) to Client Application 103. The redemption process also relies on local connectivity.

In scenario (II) of FIG. 1B, there is no connectivity between Benefit Agent 102 and Main Subsystem 101 while Client Application 103 can communicate with Benefit Agent 102 and Main Subsystem 101. This scenario can occur in stores/companies where there is no Internet connectivity. Benefit Agent 102 detects the presence of Client Application 103 through the local connectivity, and can either (a) generate a benefit for the user by using a local intelligence and send the benefit to Client Application 103, or (b) send a message to Client Application 103 to direct it to fetch the benefit directly from Main Subsystem 101. The redemption process relies on local connectivity. Since in scenario (II) there is no connectivity between Remote Agent 102 and Main Subsystem 101, the reconciliation is performed through a provisioned Key(benefit_agent).

In scenario (III) of FIG. 1B, Client Application 103 can communicate with Main Subsystem 101. However, Benefit Agent cannot communicate with either Client Application 103 or Main Subsystem 101. In this scenario, the user can manually declare its location to Main Subsystem using Client Application 103, which in turn triggers Main Subsystem 101 to send a benefit to Client Application 103 along with an associated Key(benefit) and an expiration timer. Since there is no local connectivity between Client Application 103 and Benefit Agent 102, the only possible verification scenario is when the user shows the Key(benefit) associated with the benefit to the sales rep at the company location, who can manually verify said key by entering it into Benefit Agent. After the expiration timer, the benefit is automatically erased from Client Application 103.

In scenario (IV) of FIG. 1B, Client Application 103 has no connectivity to Main Subsystem 101, but Benefit Agent 102 has connectivity to Main Subsystem 101. This scenario is similar to scenario (I) except the benefit and associated Key(benefit) are sent to Client Application by Benefit Agent 102.

Scenario (V) of FIG. 1B is an extreme case where there is no connectivity between the components of the system. In a scenario as such Benefit Agent has a provisioned Key(benefit_agent) in it. Both user and benefit agent subscribe to Main Subsystem using other means such as a web interface on another device. When Client Application 103 subscribes to the system, it can receive benefits (and associated keys) offline corresponding with many stores/companies. When the user declares its location to Client Application 103 manually, Client Application 103 checks its local database to determine if there is any associated benefit to that company. If there is a benefit, it displays the benefit (i.e., 20% discount coupon) and associated Key(benefit) (i.e., a serial number 0012435A90) with an expiration timer. The user then shows the coupon and the serial number to the sales rep, who can then verify it against Key(benefit_agent) pre-stored in said benefit agent. After the expiration timer, the benefit is automatically erased from Client Application 103.

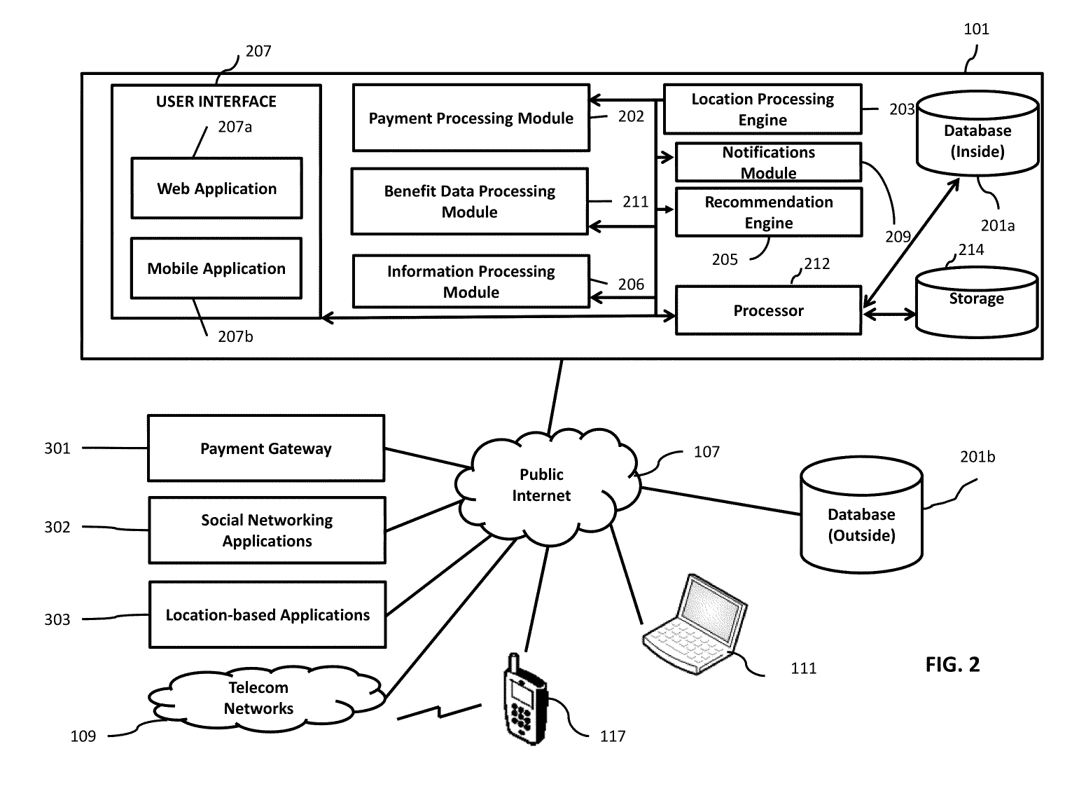

FIG. 2 illustrates Main Subsystem 101 and shows it comprises the following components:

A processor 212 and storage 214, where storage 214 stores instructions that may be executed by processor 212 to implement various functions described herein.

A user interface is a component designed specifically for subscribing users and companies to enter, delete and modify settings, configurations and data related to benefits, preferences and possibly location. There are two user interface components:
a. User interface 207a: This user interface is on a server and can be web-based and accessible through Public Internet 107.
b. User interface 207b: This user interface is designed for mobile and/or portable devices. This user interface is actually the interface of Client Application 103 and sits on user's handset 117.

A user or a company may choose to access the system through either the web-based or a mobile application-based interface interchangeably, where both interfaces provide the same information to the user.

Large-scale database 201 stores data related to companies, purchasers, benefits (coupons, campaigns and gifts), profiles, preferences, locations, transactions etc. This database can be collocated on the same computer with the Main Subsystem 101, or can be implemented on another computer. It can be centralized or distributed. As illustrated in FIG. 2, 201a is the version of database located on the same computer with the Main Subsystem server, and 201b is the version of database located on another computer, other than the Main Subsystem and can be reachable through the Public Internet 107.

Payment Processing Module 202 is a module of Main Subsystem 101 to manage money exchanges between actors of the system. This module interacts with the Payment Gateway 301 which is reachable through Public Internet 107, and serves to authorize credit card payments.

Another component is Benefit Data Processing Module 211, which handles and helps track such transactions between various actors as assignment, and redemption status of gifts and coupons. This module associates keys with benefits before sending them to Client Application 103. It also has a capability to generate and send Benefit Agent 102 its key to verify benefits. Depending on the scenario, it can also send an expiration timer associated with a benefit or configure a client application with an expiration timer setting applicable to all benefits.

Notifications Module 209 generates notifications and transmits them to companies, purchasers and recipients when a benefit is assigned or status of a benefit has changed from assigned or pending to redeemed, for example. This module can generate e-mails, SMS messages, instant messages or push-notifications to applications.

Information Processing Module 206 gathers information about the purchasers or subscribers (e.g., important dates such as birthdays, and location information through facilities such as check-in, address book, preferences, and location lists) from their existing social networking accounts or the one hosted by this service. The information obtained using this module can be stored in database 201.

Location Processing Engine 203 collects and processes information about the locations of users. This engine communicates with Benefit Agent 102 or possibly a social networking application 302, location-based applications 303, telecommunication networks 109, and the public Internet 107 to retrieve locations of subscribers.

Recommendation Engine 205 is used in determining benefits for users. This engine matches the purchaser or recipient profiles and past purchases with company benefit packages. It also provides an intelligent processing of the data to generate benefits across many companies.

The system presents a secure user interface to the companies and users through which they are able to subscribe to the services granted by the system to its subscribers, configure and modify their settings and profiles, enter their location directly into the system, issue benefits, and enjoy many more functionalities not listed here but plausibly may be delivered using such an interface whenever and however necessary.

As a matter of fact, a user interface serves the purpose of displaying the information the system has regarding the company offerings at the location of either the purchaser or the recipient. Regardless of whether companies choose to limit the goods and services that can be bought to a subset of their complete list of offerings to regular customers or not, subscribed companies provide a list of their offerings to the system. These offerings include the goods and services and their prices as well as the campaigns, promotions and coupons that are related to those goods and services.

Once a purchaser who can be a single person, a group of people, a company, a group of companies or any mixture of these decides to give a benefit to a person or a group of people, this action is recorded as a transaction in the system and the transaction is not realized until the recipient collects the benefit. Such a redemption-based charging protects purchasers from paying full-price for benefits that do not reach the intended recipients. The system may choose to keep the payment amount in its accounts until the transaction is completed, in which case it sends a redemption message to the purchasers to indicate that the recipients have collected the benefit offered by the purchasers. Alternatively, the system may charge the purchasers upon collection of benefits. The system may charge the purchasers who are the subscribers a constant daily, weekly, monthly or annual fee or on a per transaction basis. It is also possible that the subscribers that are companies may subsidize the purchases of individual people to enhance customer engagement, and treat using this system a part of its marketing plan. These are all choices that should be made by the system designers and subscribing parties.

Although the system is capable of interfacing with existing social networks, it again is a system design issue as to whether the system should develop and host a social network of its own or not to collect information regarding subscribers, instead of using the ones that already exist. The Social Networking Applications block in FIG. 2 cover this case of system-specific social network concept as well. Although shown to be located at a distant server, the location of social network applications may change for a system-owned social network based on considerations of simplicity, security etc.

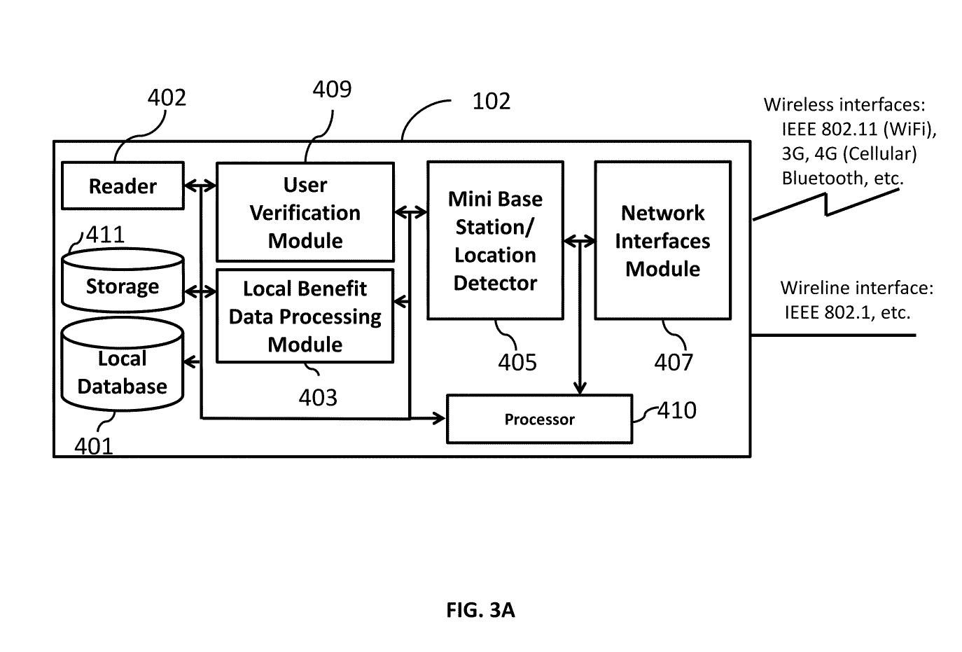

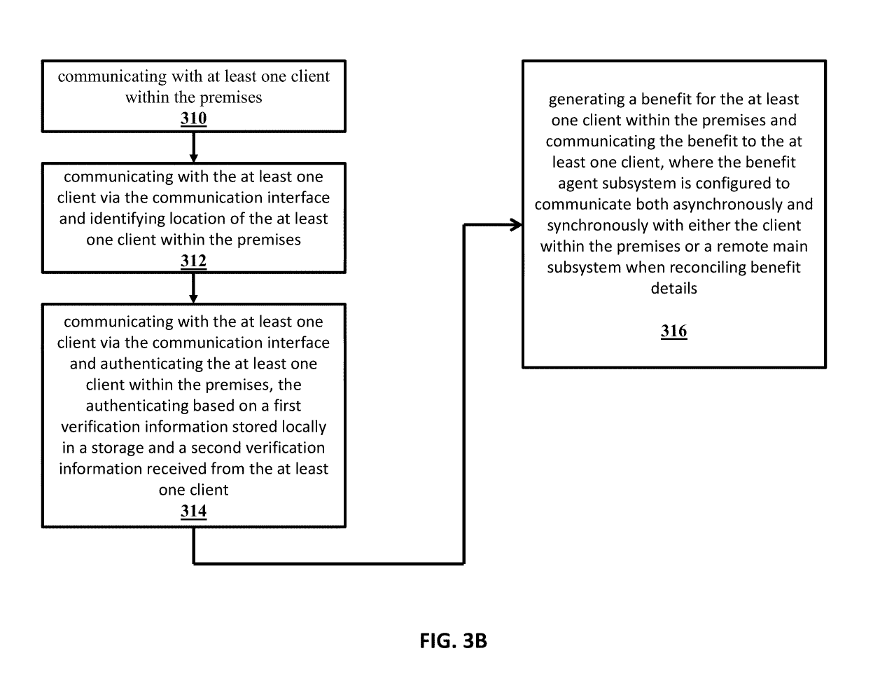

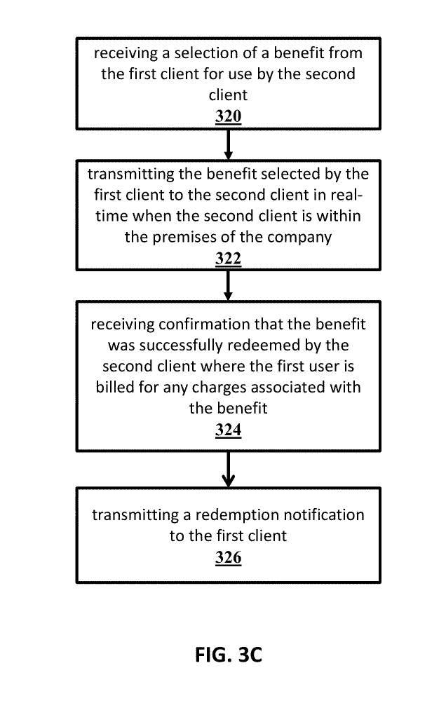

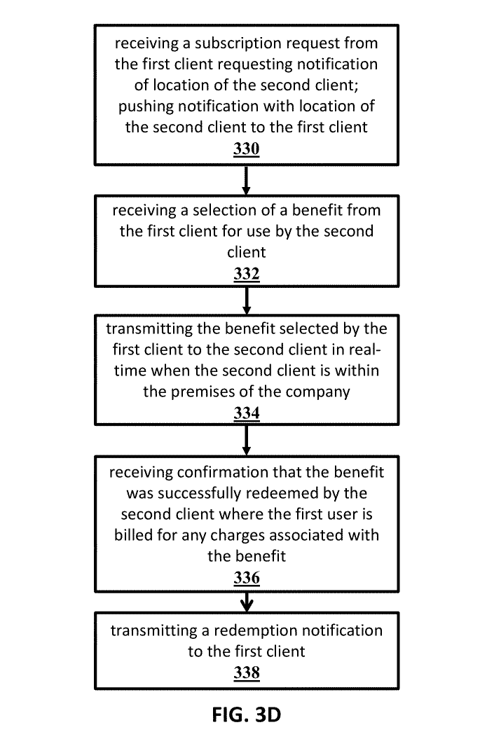

FIG. 3A illustrates a high-level block diagram of Benefit Agent 102. It connects with Client Application 103 to determine the location of the user when the user is in the near vicinity. It has Network Interfaces Module 407, which provides various network interfaces such as Cellular, WiFi and Bluetooth towards the user's handset 117. It may house a mini base station, such as a femtocell, or a location detector 405 using a non-cellular technology to provide an interface towards user's handsets. The presence of a mini base station allows Benefit Agent 102 to have a dual function for determining location of and providing telecommunication service to mobile users.

When a user is detected in the vicinity, User Verification module 409 communicates with Client Application 103 to authenticate the user. User verification is needed when a benefit (gift/coupon) is personalized. In scenarios whereby generic benefits are generated such as discount coupons user verification may not be needed, and this module does not play any role in that scenario.

Following optional authentication of the user, Local Benefit Data Processing Module 403 generates a message towards Main Subsystem 101 requesting the benefit data pertaining to the specific user. Optionally, it may have a means to generate a benefit data autonomously for the user without communicating with Main Subsystem 101, where the benefit data is stored in the local database 401. Benefit Agent's Local Benefit Data Processing Module 403 has the responsibility to verify a benefit. When a benefit's key is entered into this module (manually or received through the communications channel to the client application), Local Benefit Data Processing Module 403 performs the verification and validates the benefit. It may also ensure that the benefit has not expired.

Reader 402 is another important interface of Benefit Agent 102. It can scan a benefit data (such as the ones in the form of a barcode or a QR code) from paper or directly from the screen of a mobile handset. It sends the scanned data to the database, and through the Local Data Processing Module 403, it verifies the benefit. The Reader 402 may be on the same hardware with Benefit Agent 102 or can be an optional adjunct component.

In one particular embodiment, the present invention provides for a benefit-agent subsystem 102 located within a premises associated with a company comprising: (a) a processor 410; (b) a storage 411 storing instructions; (c) at least one communication interface 407 receiving instructions from the processor to communicate with at least one client within the premises; (d) a locator (which could be implemented, for example, as part of the user verification module 409) receiving instructions from the processor to communicate with the at least one client via the communication interface and identifying location of the at least one client within the premises; (e) an authenticator (implemented, for example, as user verification module 409) receiving instructions from the processor to communicate with the at least one client via the communication interface and authenticating the at least one client within the premises, the authenticating based on a first verification information stored locally in storage 411 and a second verification information received from the at least one client; and (f) a benefit generator (implemented, for example, as part of the local benefit data processing module 403) receiving instructions from the processor to generate a benefit for the at least one client within the premises and to communicate the benefit to the at least one client, where the benefit agent subsystem 102 is configured to communicate both asynchronously and synchronously (as outlined in FIG. 1B) with either the client within the premises or a remote main subsystem when reconciling benefit details.

In another embodiment, as depicted in FIG. 3B, the present invention discloses a method as implemented by a benefit-agent subsystem located within a premises associated with a company comprising: (a) communicating with at least one client within the premises—step 310; (b) communicating with the at least one client via the communication interface and identifying location of the at least one client within the premises—step 312; (c) communicating with the at least one client via the communication interface and authenticating the at least one client within the premises, the authenticating based on a first verification information stored locally in a storage and a second verification information received from the at least one client—step 314; and (d) generating a benefit for the at least one client within the premises and communicating the benefit to the at least one client, where the benefit agent subsystem is configured to communicate both asynchronously and synchronously with either the client within the premises or a remote main subsystem when reconciling benefit details—step 316.

In yet another embodiment, as depicted in FIG. 3C, the present invention discloses a method to generate a benefit by a first client for use by a second client, the benefit redeemable within a premises of a company, the method comprising: receiving a selection of a benefit from the first client for use by the second client—step 320; transmitting the benefit selected by the first client to the second client in real-time when the second client is within the premises of the company—step 322; receiving confirmation that the benefit was successfully redeemed by the second client where the first user is billed for any charges associated with the benefit—step 324; and transmitting a redemption notification to the first client—step 326.

In yet another embodiment, as depicted in FIG. 3D, the present invention discloses a method to generate a benefit by a first client for use by a second client, the benefit redeemable within a premises of a company, the method comprising: receiving a subscription request from the first client requesting notification of location of the second client; pushing notification with location of the second client to the first client—step 330; receiving a selection of a benefit from the first client for use by the second client—step 332; transmitting the benefit selected by the first client to the second client in real-time when the second client is within the premises of the company—step 334; receiving confirmation that the benefit was successfully redeemed by the second client where the first user is billed for any charges associated with the benefit—step 336; and transmitting a redemption notification to the first client—step 338.

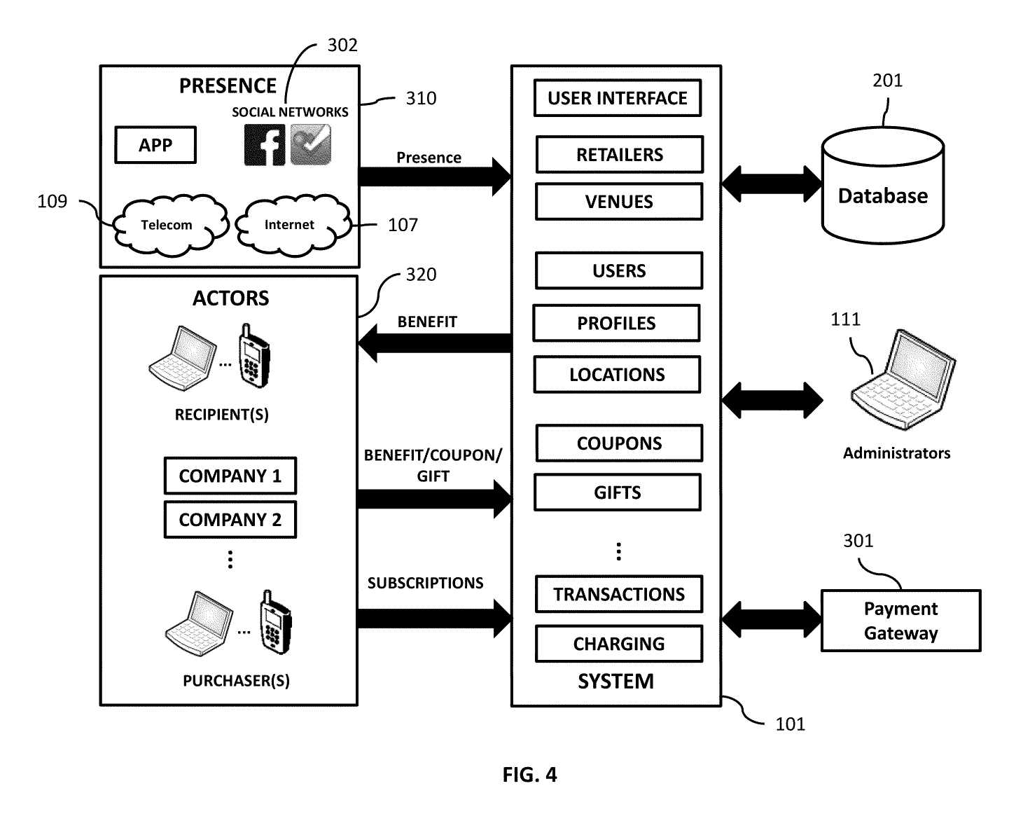

Shown in FIG. 4 is a diagram of the system of the invention which is connected to several actors that take advantage of the services given by the system, several presence information providing entities, system administrators, a large database and a payment gateway for authorization of credit card payments.

While “purchasers” and “companies” are the actors that provide gifts, coupons, campaigns and similar benefits which are likely to have monetary and/or sentimental value for the ones who receive them, the former actors also benefit from their own actions in the form of strengthened bonds and increased engagement between themselves and the recipient actors. From the perspective of service providers, the aim of this invention is to generate benefits for customers and enhance customer engagement at the same time, where the generation of benefits may be attributed to a group of people and/or a group of companies depending on the particular scenario. In general, friends and family members are expected to subscribe to the system to buy gifts for the ones they love and care for, while companies are to distribute explicit and implicit coupons and benefits to those who buy or receive the gifts by selling items at discounted prices or reduced installments. The benefit to a recipient can be a “combination” of a gift from a friend or a group of friends and one or more company coupons. In an exemplary scenario for a combination benefit, receiving a gift from a friend (purchaser) in a particular store (Company 1) provides an added benefit of a 40% discount on a second purchase at that store using a certain credit card (Company 2) to the user (recipient).

Since one of the main objectives is to increase customer visits, it is essential that either the recipient(s) or the purchaser(s) are at the company premises or near its immediate vicinity. The system allows subscribed purchasers to buy gifts for recipients located at the company whereabouts, which can be collected by the recipients almost in real-time. It is also possible that subscribed purchasers at the company premises are able to buy gifts for their family and friends who are not with them at the location to be collected at a future date. The companies that seek increases in their number of customers and improvements in customer engagement sponsor partially or wholly these gifts by offering purchasers discounts or easier payment options as well as promotions, campaigns and coupons to both the purchasers and the recipients. The system can push the benefit data pertaining to gifts, which is created by the purchasers and possibly contributed to by the companies to respective recipients. Alternatively, recipients may pull benefit data when they are at certain locations.

An indispensable component of this system is the location or so-called presence information supplied by one or more of the wireless, mobile or fixed telecommunication networks, public Internet, social networking, location-based services and applications, and the users themselves. While it is possible to locate users automatically by means of advanced technology and algorithms such as the triangulation method in wireless networks or through IP detection in fixed networks, users may also transmit their location to social networking and location-based services and applications as well as directly to the system at their own discretion.

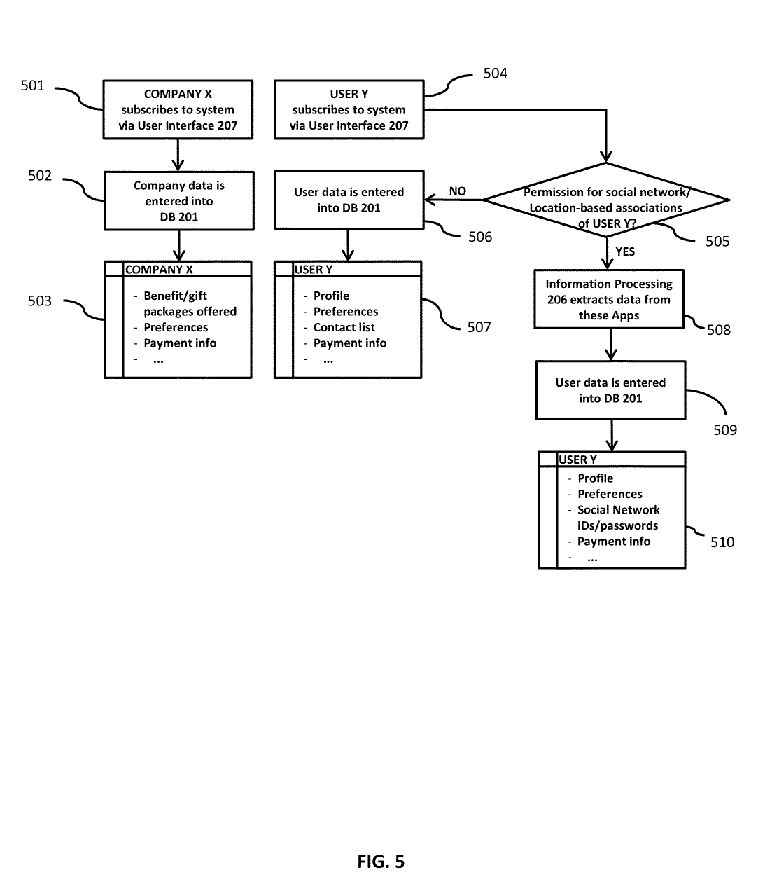

It should be emphasized that the system is only able to access the information of those users and companies that have become subscribers of the system by completing the subscription process. FIG. 5 depicts the subscription process. Using user interface 207 of the system, Company X subscribes to the system in step 501. Company X enters gift/benefit packages to be offered to users in step 502. Such data can be modified or updated by Company X at any time. Similarly, using the user interface 207 of the system, users can subscribe to the system in step 504 by entering their profiles and preferences. This information is entered into database 201 in step 506. The system also checks to determine if the user gives permission for the system to access his existing social network accounts and location-based applications in checkpoint 505. If the user gives permission, relevant information (such as contact list and important dates) is extracted from such applications in step 508, and gets entered into the database in step 509.

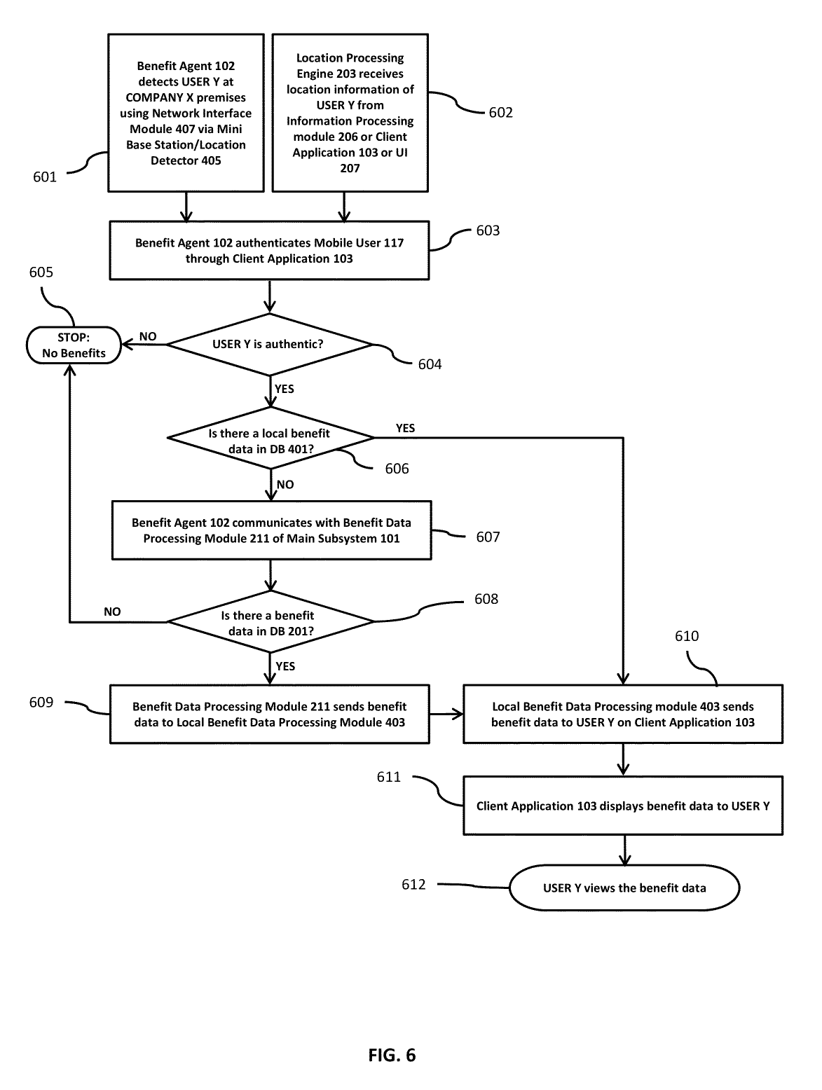

FIG. 6 shows the steps of a process where user Y receives a benefit at Company X premises. As the first step, Benefit Agent 102 detects user Y′s presence at Company X premises using Network Interface Module 407 by communicating with Client Application 103 in step 602. Benefit Agent 102 tries to authenticate user Y′s Client Application 103 in step 603. At checkpoint 604, it checks to determine if the user is authentic. If it is not, the process stops at step 605. If the user authentication is successful, it checks to determine if there is a local benefit data at Benefit Agent 102 for the user at step 606. If there is not any local benefit data, Benefit Agent 102 communicates with Benefit Data Processing Module 211 of the main system 101 by establishing a connection through public internet 107. The main system's benefit data processing module checks to determine if there is a benefit data for user Y in database 201 in step 608. If there is a benefit data, then in step 609, this data is transferred to Benefit Agent's local benefit data processing module 403 to be delivered to user Y. If there is no benefit data, then the system does not generate any benefit data and the process terminates in step 605. If there is a locally stored benefit data in Benefit Agent 102 or there is a benefit data received from the main subsystem in step 609, Local Benefit Data Processing Module 403 sends this data to user Y′s Client Application 103. The user may receive the benefit as a coupon or a gift with a code. This data gets displayed in step 611 at Client Application 103′s interface (screen) so that user Y sees it. It can also generate an audio message. User Y views the benefit data in step 612.

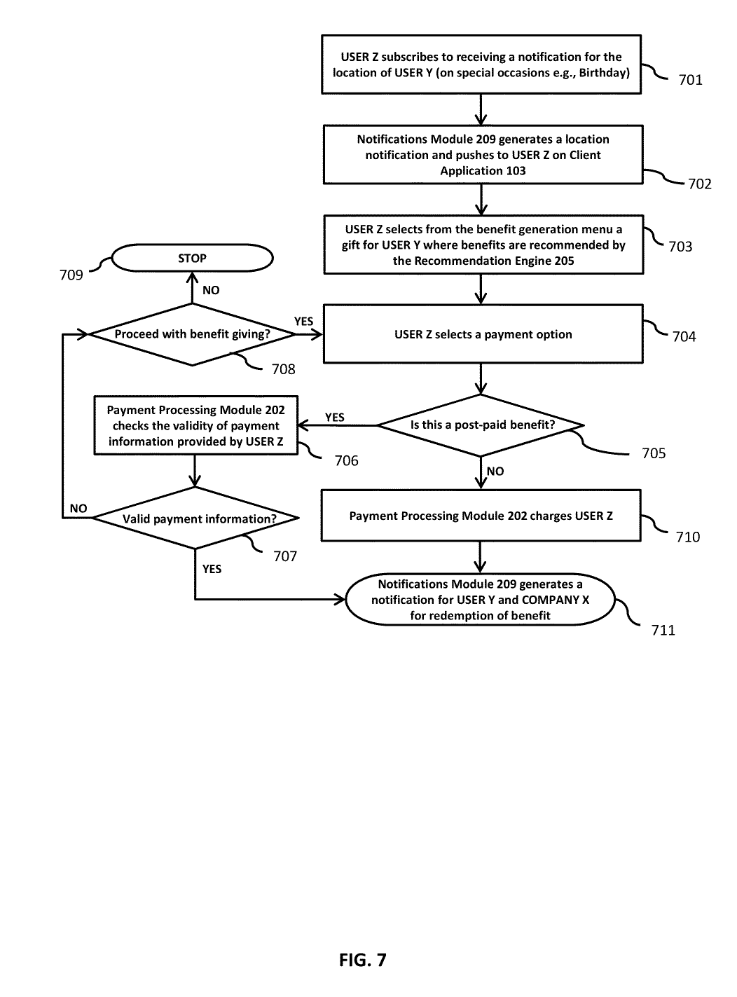

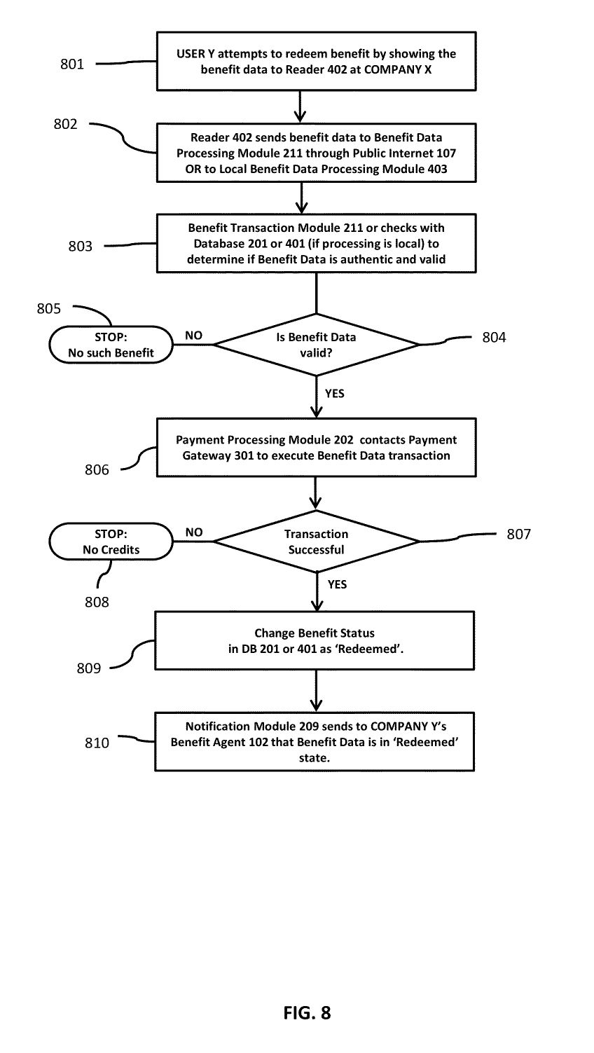

There are many creative flow scenarios for gift giving. For example, in one possible scenario, the gift purchaser may purchase the gift beforehand to be sent to the recipient at a particular date or upon arrival at a particular venue, or both. In another possible scenario, the gift can be purchased in real-time when the recipient is at a specific venue (i.e., at a bar or restaurant). In this scenario, the gift purchaser receives an instant notification about the recipient's whereabouts. In another scenario, the purchaser can purchase the gift in real-time at a specific date (i.e., at a birthday or anniversary). There may be other scenarios in which a group of purchasers may be collectively buying a gift for a recipient at a specific date or at a specific location. Alternatively, there may be a combination benefit, where a purchaser may buy a gift for a recipient to be delivered at a location and/or at a date, and the system may send an additional benefit or a coupon along with the gift. All the benefit generation scenarios may employ the recommendation engine. Although all of these flow scenarios will not be described in this specification, one of the exemplifying scenarios is described in FIG. 7. A person skilled in the art can generate the flows for the other aforementioned scenarios. In this flow, a user (say user Z) subscribes to the system to receive notification of user Y′s location possibly on a certain occasion (i.e., birthday) to send a gift.

In FIG. 7 the steps of benefit giving from user Z to user Y in the form or a gift is shown. In step 701, user Z subscribes to the system with a request to receive notification on user Y′s location on his birthday. Notifications Module 209 generates a location notification (for example, user Y is at Company X premises), and sends it to client application 103 of user Y in step 702. Simultaneously, in step 703, the system sends user Y the recommended gifts for user Z, which are generated through Recommendation Engine 205. This step assumes that Company X is also a subscriber of the system and their menu of benefit options are in the database of the main subsystem. At step 704 user Z selects a payment option for the gift he/she will buy. At checkpoint 705, the system checks to determine if it is a post-paid benefit. If it is not, in step 710, user Z is charged through Payment Processing Module 202. If the user is using a post-paid option, then in step 707, Payment Processing Module 202 checks the validity of the payment information of user Z. If the payment information is valid, the system's Notification Module 209 generates a benefit notification to user Y, and (optionally) to Company X. If the payment information is not valid, user Z is given the option to select or update the payment information through checkbox 708, or give up the gift giving in step 709. If user Z wants to update payment information, the process continues through step 704.

In this flow, user Z receives a notification from the notifications module of the system concerning the birthday of one of his/her friend user Y. This information may be retrieved from an existing social network account, the social network of the system or the data entered into the system. Viewing the user interface of the system user Z may select a gift/benefit for his/her friend user Y beforehand from a menu of gift/benefit options displayed on the user interface. These options can be generated with the aid of the recommendation engine of the system. After completion of selection, the benefit transaction module sets the transaction status as “BENEFIT SELECTED”. The actual processing of the benefit however occurs at the event day.

Logical operations associated with the various functionalities described above can be implemented as modules configured to control a processor to perform particular functions. For example, computer readable program code may be executed by a processor to perform particular steps or a series of steps. These modules may be stored on storage devices and loaded into memory at runtime or may be stored as would be known in the art in other computer-readable memory locations.

In one embodiment, computer readable program code may control a processor to perform the following steps: (a) communicate with at least one client within a company's premises; (b) communicate with the at least one client via the communication interface and identifying location of the at least one client within the premises; (c) communicate with the at least one client via the communication interface and authenticate the at least one client within the premises, where the authentication is based on a first verification information stored locally in a storage and a second verification information received from the at least one client; and (d) generate a benefit for the at least one client within the premises and communicate the benefit to the at least one client, where the benefit agent subsystem is configured to communicate both asynchronously and synchronously with either the client within the premises or a remote main subsystem when reconciling benefit details.

In another embodiment, computer readable program code may control a processor to perform the following steps: receive a selection of a benefit from the first client for use by the second client; transmit the benefit selected by the first client to the second client in real-time when the second client s within the premises of the company; receive confirmation that the benefit was successfully redeemed by the second client where the first user is billed for any charges associated with the benefit; and transmit a redemption notification to the first client.

In another embodiment, computer readable program code may control a processor to perform the following steps: receive a subscription request from a first client requesting notification of location of a second client; push notification with location of the second client to the first client; receive a selection of a benefit from the first client for use by the second client; transmit the benefit selected by the first client to the second client in al-time when the second client is within the premises of the company; receive confirmation that the benefit was successfully redeemed by the second client where the first user is billed for any charges associated with the benefit; and transmit a redemption notification to the first client.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

### CONCLUSION

A system and method has been shown in the above embodiments for service providers which employ multiuser software platforms for campaign, gift and/or gift management, with the system having a main software system, a completely distributed software and hardware system where each component is located at a benefit giver (company)'s premises, and a client application designed for mobile handsets. The system generates an intelligent benefit in real-time based on the user's location and profile (it can be a special day, for example), wherein the benefit can be a coupon or a gift. In the scenario of a gift, the system handles payment. The system is designed in a distributed manner to increase the resilience to network connection loss or dependency on existence of network connections.

While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

1. A benefit-agent subsystem located within a premises associated with a company comprising:
a. a processor;
b. a storage storing instructions;
c. at least one communication interface receiving instructions from said processor to communicate with at least one client within said premises;
d. a locator receiving instructions from said processor to communicate with said at least one client via said communication interface and identifying location of said at least one client within said premises;
e. an authenticator receiving instructions from said processor to communicate with said at least one client via said communication interface and authenticating said at least one client within said premises, said authenticating based on a first verification information stored locally in said storage and a second verification information received from said at least one client; and
f. a benefit generator receiving instructions from said processor to generate a benefit for said at least one client within said premises and to communicate said benefit to said at least one client,
where said benefit agent subsystem is configured to communicate both asynchronously and synchronously with either said client within said premises or a remote main subsystem when reconciling benefit details.

2. The benefit-agent subsystem of claim 1, wherein said authenticating is based on two keys, where a first key is stored locally in said storage and a second key is received from said at least one client, where said authenticator performs authentication process as a function of said first and second keys.

3. The benefit-agent subsystem of claim 1, wherein said benefit generator additionally transmits an expiration timer indicating expiration time of said benefit.

4. The benefit-agent subsystem of claim 1, wherein said client is a client application running on a mobile device.

5. The benefit-agent subsystem of claim 1, wherein said benefit is determined based on a profile associated with said client.

6. The benefit-agent subsystem of claim 1, wherein said benefit is determined based on a recommendation by a recommendation engine which matches client profiles with a benefit package of said company.

7. A method as implemented by a benefit-agent subsystem located within a premises associated with a company comprising:
a. communicating with at least one client within said premises;
b. communicating with said at least one client via said communication interface and identifying location of said at least one client within said premises;
c. communicating with said at least one client via said communication interface and authenticating said at least one client within said premises, said authenticating based on a first verification information stored locally in a storage and a second verification information received from said at least one client; and
d. generating a benefit for said at least one client within said premises and communicating said benefit to said at least one client,
where said benefit agent subsystem is configured to communicate both asynchronously and synchronously with either said client within said premises or a remote main subsystem when reconciling benefit details.

8. The method of claim 7, wherein said step of authenticating is based on two keys, a first key stored locally in said storage and a second key received from said at least one client, where authentication is performed as a function of said first and second keys.

9. The method of claim 7, wherein said method further comprises transmitting an expiration timer indicating expiration time of said benefit.

10. The method of claim 7, wherein said client is a client application running on a mobile device.

11. The method of claim 7, wherein said method further comprises determining said benefit based on a profile associated with said client.

12. The method of claim 7, wherein said method further comprises consulting a recommendation engine to determine said benefit, said recommendation engine which matches client profiles with a benefit package of said company.

13. A method to generate a benefit by a first client for use by a second client, said benefit redeemable within a premises of a company, said method comprising:
receiving a selection of a benefit from said first client for use by said second client;
transmitting said benefit selected by said first client to said second client in real-time when said second client is within said premises of said company;
receiving confirmation that said benefit was successfully redeemed by said second client where said first user is billed for any charges associated with said benefit; and
transmitting a redemption notification to said first client.

14. The method of claim 13, where said selection of said benefit by said first client is made from any of or a combination of the following: a list provided by a recommendation engine, information retrieved from a user profile, or information gathered from social networking platforms.

15. The method of claim 13, where said benefit is transmitted to said second client within said premises by a benefit agent located within said premises.

16. The method of claim 13, where said benefit is transmitted to said second client from a remote main subsystem maintaining benefit information.

17. The method of claim 13, where, prior to transmitting said benefit, said method further comprises authenticating said second client within said premises, said authenticating based on a first verification information stored in a storage that is local to said premises and a second verification information received from said second client.

18. The method of claim 19, wherein said first verification information is a first key and said second verification is a second key, where authentication is a function of said first and second keys.

19. A method to generate a benefit by a first client for use by a second client, said benefit redeemable within a premises of a company, said method comprising:
receiving a subscription request from said first client requesting notification of location of said second client;
pushing notification with location of said second client to said first client;
receiving a selection of a benefit from said first client for use by said second client;
transmitting said benefit selected by said first client to said second client in real-time when said second client is within said premises of said company;
receiving confirmation that said benefit was successfully redeemed by said second client where said first client is billed for any charges associated with said benefit; and
transmitting a redemption notification to said first client.

20. The method of claim 21, where said selection of said benefit by said first client is made from any of or a combination of the following: a list provided by a recommendation engine, information retrieved from a user profile, or information gathered from social networking platforms.

21. The method of claim 21, where, prior to transmitting said benefit, said method further comprises authenticating said second client within said premises, said authenticating based on a first verification information stored in a storage that is local to said premises and a second verification information received from said second client.

22. The method of claim 20, wherein said first verification information is a first key and said second verification is a second key, where authentication is a function of said first and second keys.
